(19) United States
(12) Patent Application Publication
(10) Pub. No.: US 2004/0066988 A1
(43) Pub. Date: Apr. 8, 2004

(54) Plastic bag with bottom enhancement arrangement and producing method thereof

(76) Inventor: Jenny Jie Yi Li, Los Angeles, CA (US)

Correspondence Address: Raymond Y. Chan, Suite 128, 108 N. Ynez Avenue, Monterey Park, CA, 91754, US

(21) Appl. No.: 10/263,878

(22) Filed: Oct. 4, 2002

(51) Int. Cl. B65D 30/20; B31B 1/26

(52) U.S. Cl. 383/120; 383/121; 493/244

(57) ABSTRACT

A plastic bag includes a bag body having an top opening, a bottom edge, and a trash chamber defining therebetween, and a bottom enhancement arrangement including a sealing edge formed along the bottom edge of the bag body in such a manner that when the bag body is folded into an usage condition, the sealing edge is inwardly flipped into the trash chamber while two bottom side portions of the bag body is downwardly folded to form a round bottom portion of the trash chamber for evenly distributing a weight of the trashes so as to protect the sealing edge from being broken by means of the weight of the trashes.

### FIELD OF INVENTION

The present invention relates to a plastic bag, and more particularly to a plastic bag with a bottom enhancement arrangement and a producing method thereof, wherein the bottom enhancement arrangement is capable of enhancing a strength of the plastic bag to prevent the plastic bag from being broken at the bottom portion thereof while the trash is collected in the plastic bag.

### DESCRIPTION OF RELATED ARTS

A plastic bag is commonly used for collecting trash. The user usually puts the plastic bag in a trashcan such that, when the trashcan is full, the user can simply take out the plastic bag and keep the trashcan clean.

A conventional manufacturing method of plastic bag comprises the steps of: (a) placing a raw material into a mold to form a hollow plastic piece; (b) providing a thermal cut on the plastic piece to form a sealing line along the bottom edge of the plastic bag so as to form a closed end at the bottom edge of the plastic bag; and (c) overlappedly folding the plastic bag in a longitudinal direction for storing purpose.

However, the conventional plastic bag has several drawbacks. When the plastic bag is full, the weight of the trash will break the seal of the bottom edge of the plastic bag. In order to lower the cost of the plastic bag, the manufactures try to minimize the use of raw material, i.e. the thickness of the plastic bag, so as to weaken the sealing line at the bottom edge of the plastic bag.

Especially, when the user puts the fluid formed trash, such as soda or juice, into the plastic bag, the fluid trash will be moved at one side of the plastic bag. Due to the uneven weight of the trash inside the plastic bag, the fluid trash will break the sealing line to form a slit in such a manner that the fluid trash will leak through the slit.

Moreover, when the plastic bag is used to collect the solid trash, the trash cannot fittedly fill into two bottom corner portions of the plastic bag, such that the storing space at the two corner portions of the plastic bag is wasted. Thus, the weight of the trash is mainly distributed at a mid portion of the bottom edge of the plastic bag. Therefore, the sealing line at the mid portion of the bottom edge of the plastic bag will be broken easily even though the plastic bag is not full yet.

To solve the above problem, the user can tie a knot at the bottom portion of the plastic bag in such a manner that the bottom portion of the plastic bag is formed in a spherical shape. It is worth mentioning that the spherical shaped of the bottom portion of the plastic bag can evenly distributed the weight of the trash therein so as to prevent sealing line from being broken. In addition, the sealing line is tightened up in the knot so as to ensure the protection of the sealing line of the plastic bag. In other words, when the knot is formed at the bottom portion of the plastic bag, the plastic bag is capable of holding more weight of trash than the plastic bag without the knot.

However, a certain storing space of the plastic bag is wasted to compensate the form the knot since the bottom portion of the plastic bag is used up. Furthermore, the weight of the trash, especially the fluid trash, is concentrated at the knot to stretch out the plastic bag such that once the knot is loosen, the sealing line will be broken easily by overloading the trash in the plastic bag. In addition, it is a hassle for the user to tie the knot for every plastic bag, especially he or she must clean up the trashcan every day such as in the restaurant or in the fast food shop.

### SUMMARY OF THE PRESENT INVENTION

A main object of the present invention is to provide a plastic bag with a bottom enhancement arrangement which is capable of enhancing the strength of the plastic bag to prevent the plastic bag from being broken at the bottom portion thereof while the trash is collected in the plastic bag.

Another object of the present invention is to provide a plastic bag with a bottom enhancement arrangement, wherein the plastic bag is overlappedly folded into a compact size for storage. When the plastic bag is unfolded to use, the bottom portion of the plastic bag is formed in a round shape to evenly distribute the weight of the trash. Therefore, the plastic bag of the present invention is capable of holding 10-15% more weight of the trash than the conventional plastic bag with the same thickness.

Another object of the present invention is to provide a plastic bag with a bottom enhancement arrangement, wherein the sealing line along the bottom portion of the plastic bag is folded into the trash chamber when the plastic bag is unfolded to use, in such a manner that the sealing line is tightened by the trash when the trash is collected in the trash chamber of the plastic bag so as to prevent the sealing line from being broken by the weight of the trash.

Another object of the present invention is to provide a method of producing a plastic bag with a bottom enhancement arrangement, wherein the manufacturing method does not require expensive machines and involved complicated structure so as to minimize the manufacturing cost of the plastic bag incorporating with the bottom enhancement arrangement.

Another object of the present invention is to provide a method of producing a plastic bag with a bottom enhancement arrangement, wherein the manufacturing method of the bottom enhancement arrangement does not require any additional step in the manufacturing process of the plastic bag, so as to provide a lower cost of the plastic bag with enhanced strength thereof.

Accordingly, in order to accomplish the above objects, the present invention provides a plastic bag comprising:

a bag body having an top opening, a bottom edge, and a trash chamber defining therebetween, wherein the bag body is adapted to be folded from a storage condition to an usage condition, wherein at the storage condition, the bag body is overlapped to form a longitudinal strap like shape, and at the usage condition, the bag body is unfolded to expand a space of the trash chamber for collecting trashes therein; and

a bottom enhancement arrangement comprising means for sealing the bottom edge of the bag body to form a sealing edge of the bag body in such a manner that when the bag body is folded into the usage condition, the sealing edge is inwardly folded into the trash chamber to provide a round shape bottom portion of the trash chamber for evenly distributing a weight of the trashes so as to protect the sealing edge from being broken by means of the weight of the trashes.

In addition, the present invention further provides a method of producing a plastic bag, comprising the steps of:

(a) deforming a raw material to form a plastic tubular body having two opening ends and two longitudinal half sections with respect to a centerline of the tubular body, wherein each of the longitudinal half sections has an outer longitudinal edge extended from one opening end to another opening end, an outer longitudinal portion transversely extended from the respective outer longitudinal edge, and an inner longitudinal portion defined between the respective outer longitudinal portion and the centerline;

(b) inwardly folding each of the outer longitudinal edges of the tubular body toward the centerline thereof to overlappedly receive the outer longitudinal portion in the inner longitudinal portion;

(c) folding the two longitudinal half sections with each other; and

(d) sealing one of the opening ends of the tubular body to form a bottom sealing edge of the plastic bag.

### BRIEF DESCRIPTION OF THE DRAWINGS

FIG. 1 is a perspective view of a plastic bag with a bottom enhancement arrangement according to a preferred embodiment of the present invention.

FIG. 2 illustrates the plastic bag with a bottom enhancement arrangement in a storage condition according to the above preferred embodiment of the present invention.

FIG. 3 illustrates the plastic bag with a bottom enhancement arrangement in a usage condition according to the above preferred embodiment of the present invention, showing the sealing edge of the plastic bag folding into the trash chamber thereof.

FIG. 4 illustrates an alternative mode of the plastic bag with a bottom enhancement arrangement according to the above preferred embodiment of the present invention.

FIG. 5 is a perspective view of a tubular body of the plastic bag according to the above preferred embodiment of the present invention.

FIG. 6 is a flow diagram illustrating a method of producing the plastic bag with a bottom enhancement arrangement according to the above preferred embodiment of the present invention.

### DETAILED DESCRIPTION OF THE PREFERRED EMBODIMENT

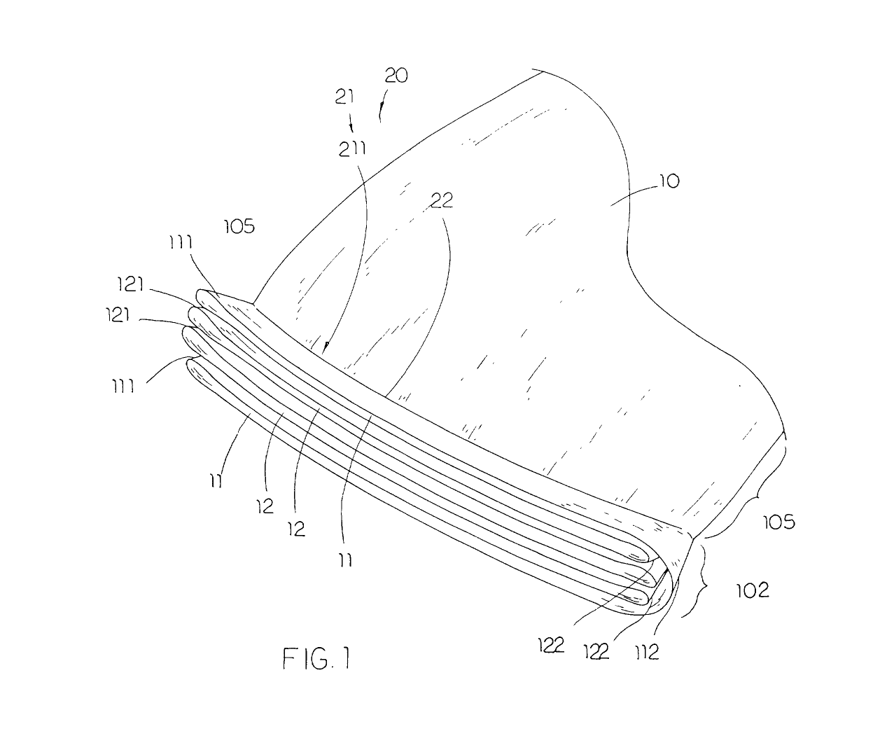

Referring to FIGS. 1 through 3 of the drawings, a plastic bag according to a preferred embodiment of the present invention is illustrated, wherein the plastic bag comprises a bag body 10 and a bottom enhancement arrangement 20.

The bag body 10 has an top opening 101, a bottom edge 102, and a trash chamber 103 defining therebetween, wherein the bag body 10 is adapted to be folded from a storage condition to an usage condition, wherein at the storage condition, the bag body 10 is overlapped to form a longitudinal strap like shape, and at the usage condition, the bag body 10 is unfolded to expand a space of the trash chamber 103 with a round bottom portion 104 for collecting trashes therein.

The bottom enhancement arrangement 20 comprises means 21 for sealing the bottom edge 102 of the bag body 10 to form a sealing edge 22 of the bag body 10 in such a manner that when the bag body 10 is folded into the usage condition, the sealing edge 22 is inwardly flipped into the trash chamber 103 to provide a round bottom portion 104 of the trash chamber 103 for evenly distributing a weight of the trashes so as to protect the sealing edge 22 from being broken by means of the weight of the trashes.

As shown in FIG. 1, when the bag body 10 is in the storage condition, the bag body 10 has two outer covering layers 11, each having a longitudinal outer covering edge 111 and a longitudinal inner covering edge 112, and two inner lining layers 12, each having a longitudinal outer lining edge 121 and a longitudinal inner lining edge 122, overlappedly disposed between two outer covering layers 11 in layer by layer manner, wherein two outer sides of the outer covering layers 11 are integrally connected at the inner covering edges 112 thereof and two inner sides of the lining layers 12 are integrally connected at the inner lining edges 122 thereof. Moreover, two inner sides of the inner covering edges 112 of the outer covering layers 11 are integrally connected to two outer sides of the inner lining edges 122 of the inner lining layers 12 respectively. It is worth mentioning that each of the outer covering layers 11 and the inner lining layers 12 is embodied as two overlapped sheets in an edge to edge manner, as shown in FIG. 1.

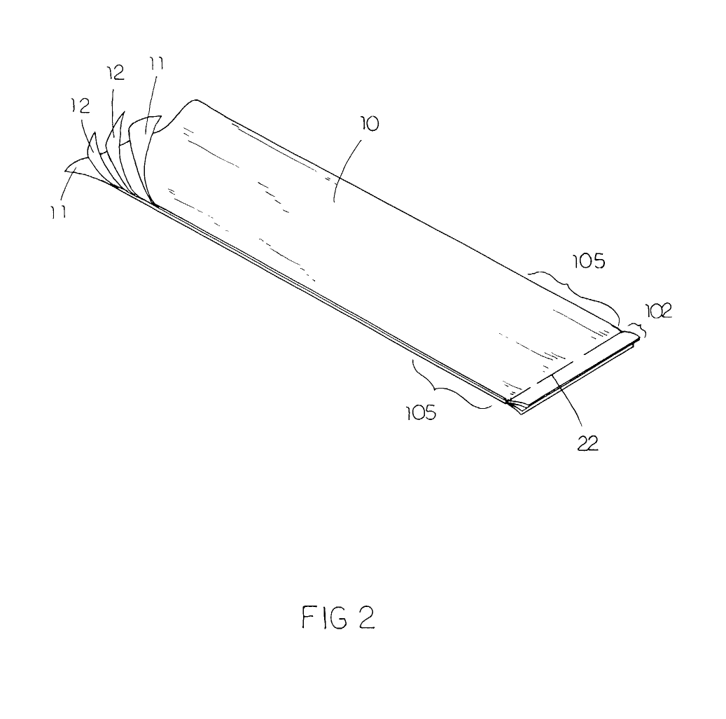

Accordingly, a width of each of the inner lining layers 12 is slightly shorter than that of each of the outer covering layers 11 in such a manner that when the bag body 10 is in the storage condition, the inner lining layers 12 are overlappedly and fittedly sandwiched between the outer covering layers 11 so as to form a longitudinal strap liked shape, as shown in FIG. 2.

The sealing means 21 comprises at least one line of ultrasonic welding spots 211 spacedly aligned along the bottom edge 102 of the bag body 10 at the storage condition to form the sealing edge 22 thereof, in such a manner that the outer covering layers 11 and the inner lining layers 12 are sealedly bonded with each other at the bottom edge 102 of the bag body 10. Accordingly, the ultrasonic welding spots 211 are aligned closely together to provide good sealing and affixing features.

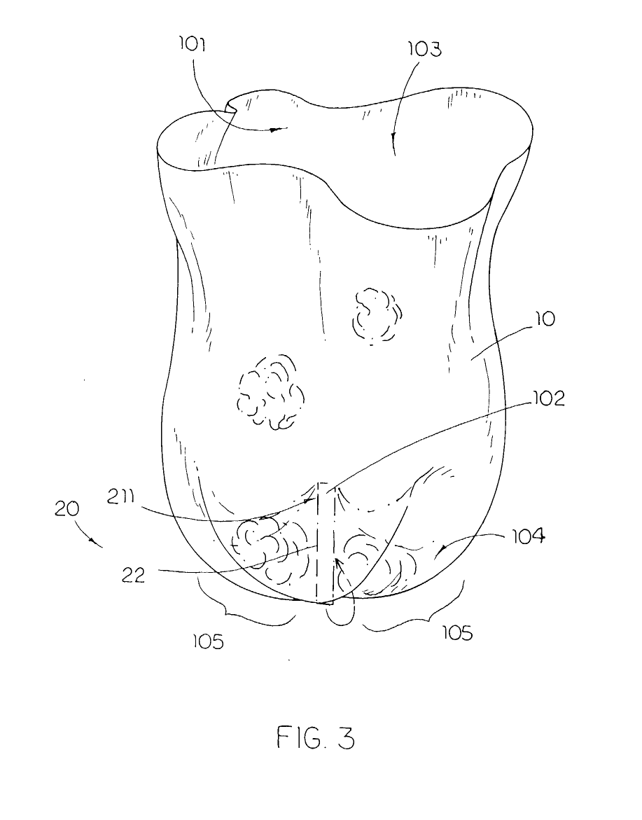

When the bag body 10 is folded into the use condition, the bottom edge 102 of the bag body 10 is folded inwardly to the trash chamber 103 while two bottom side portions 105 of the bag body 10 are moved downwardly to form the round bottom portion 104 of the bag body 10, as shown in FIG. 3.

Therefore, when the trashes are thrown in the trash chamber 103 of the bag body 10, the bottom edge 102 of the bag body 10 are surrounded with the trashes. Due to the weight of the trashes, the sealing edge 22 along the bottom edge 102 of the bag body 10 is substantially gripped by the trashes to protect the sealing edge 22 of the bottom enhancement arrangement 20 from being broken so as to prevent the trashes leaking from the bottom edge 102 of the bag body 10, as shown in FIG. 3. In addition, no space of the trash chamber 103 is wasted with respect to the bottom enhancement arrangement 20 so that the bag body 10 is allowed to fully unfold to maximize the space of the trash chamber 103.

It is worth mentioning that the round bottom portion 104 of the trash chamber 103 is capable of enhancing the strength of the bag body 10 since the weight of the trashes inside the trash chamber 103 can be evenly distributed on the round bottom portion 104 thereof. Therefore, when the bag body 10 incorporated with the bottom enhancement arrangement 20, the plastic bag of the present invention is capable of holding 10 to 15% more weight of the trash in comparison with the same thickness of the conventional plastic bag. In other words, comparing the plastic bag of the present invention with the conventional plastic bag, the bag body 10 of the present invention can be 10 to 15% thinner than the convention plastic bag to hold the same weight of the trash. Therefore, the material cost of the plastic bag of the present invention is substantially reduced while the strength of the plastic bag remains the same.

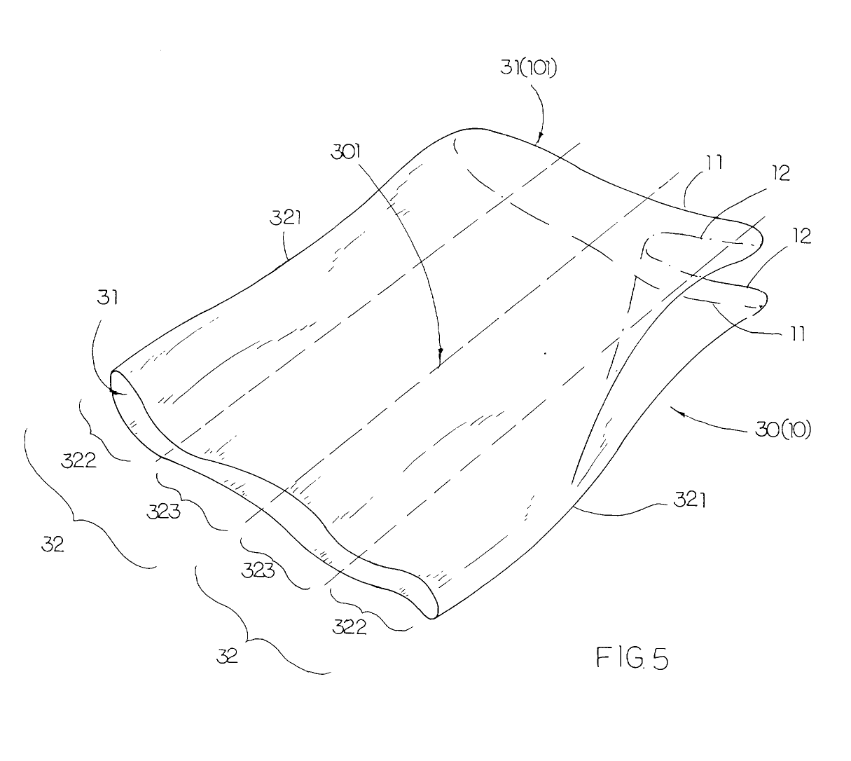

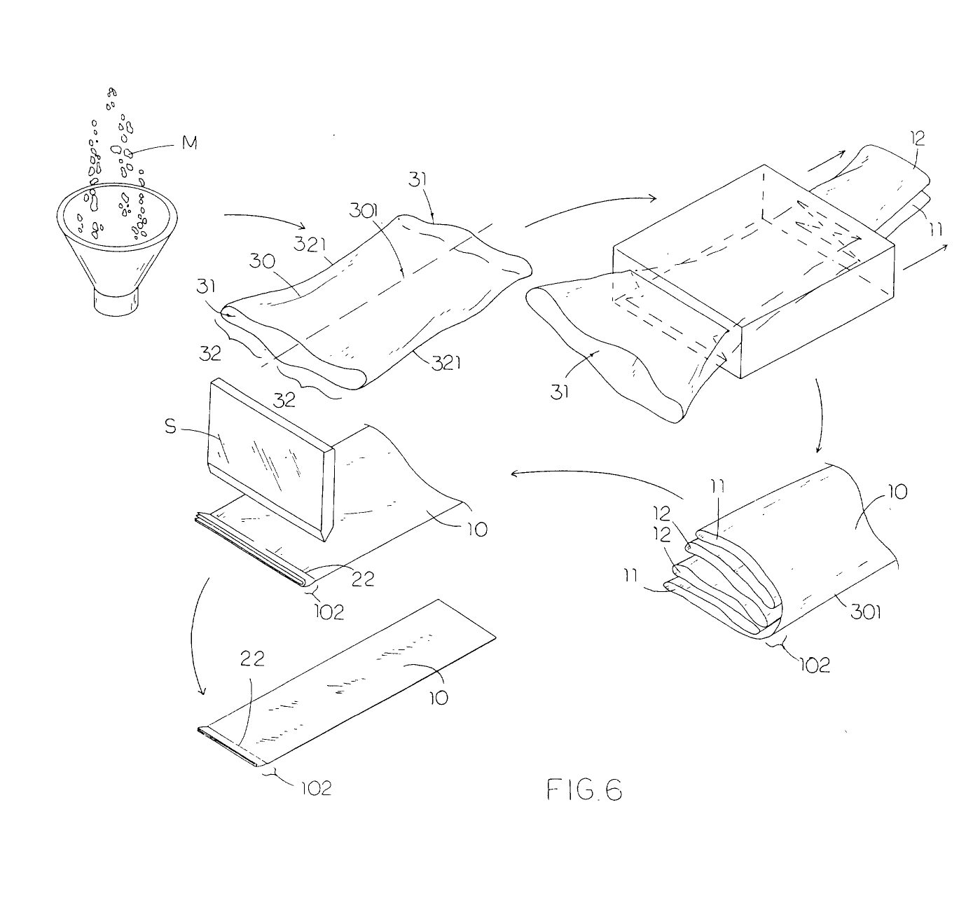

Referring to FIGS. 5 and 6, the present invention further comprises a method of producing the plastic bag with the bottom enhancement arrangement 20, which comprises the following steps.

(1) Deform a raw material M to form a plastic tubular body 30 having two opening ends 31 and two longitudinal half sections 32 with respect to a centerline 301 of the tubular body 30, wherein each of the longitudinal half sections 32 has an outer longitudinal edge 321 extended from one opening end 31 to another opening end 31, an outer longitudinal portion 322 transversely extended from the respective outer longitudinal edge 321, and an inner longitudinal portion 323 defined between the respective outer longitudinal portion 322 and the centerline 301.

(2) Inwardly fold each of the outer longitudinal edges 321 of the tubular body 30 toward the centerline 301 thereof to overlappedly receive the outer longitudinal portion 322 in the inner longitudinal portion 323.

(3) Fold the two longitudinal half sections 32 with each other along the centerline 301 of the tubular body 30.

(4) Seal one of the opening ends 31 of the tubular body 30 to form the bottom sealing edge 22 of the bag body 10 of the plastic bag.

In step (1), the tubular body 30 is made of the plastic raw material M by injection molding techniques commonly known to those skilled in the art. The tubular body 30 basically is the bag body 10 when the bag body 10 is unfolded, wherein one of the opening ends 31 of the tubular body 10 is constructed to be the top opening 101 of the bag body 10 while another opening ends 31 of the tubular body 30 is constructed to be sealed to form the bottom edge 102 of the bag body 10. Moreover, the centerline 301 of the tubular body 30 is defined at a longitudinal line thereof to form the two identical longitudinal half sections 32 of the tubular body 30.

In step (2), the two outer longitudinal edges of the tubular body 30 are inwardly folded to the centerline 301 thereof through a mold M in such a manner that the outer longitudinal portion 322 of the tubular body 30 is overlappedly disposed in the inner longitudinal portion 323 thereof.

Accordingly, after overlappedly folding the outer longitudinal portion 322 in the inner longitudinal portion 323, each of the longitudinal half sections 32 forms the respective outer covering layer 11 and the inner lining layer 12 of the bag body 10 by the outer longitudinal portion 322 and the inner longitudinal portion 323 of the tubular body 30.

In step (3), the bag body 10 is formed by overlappedly folding the two longitudinal half sections 32 with each other along the centerline 301 of the tubular body 30, wherein the two inner lining layers 12 are overlappedly folded with each other and are overlappedly sandwiched between the two outer covering layers 11.

In step (4), an ultrasonic welding device S is applied on the bag body 10 along the respective opening end 31 to form the line of ultrasonic welding spots 211 so as to form the sealing edge 22 sealed along the bottom edge 102 of the bag body 10. Accordingly, the sealing means 20 can be a thermal cut along the bottom edge 102 of the bag body 10 that the sealing technique is commonly known to those skilled in the art.

In addition, a width of the outer longitudinal portion 322 of the tubular body 30 is slightly smaller than that of the inner longitudinal portion 323 thereof, in such a manner that when the outer longitudinal portion 322 is inwardly folded to overlap with the inner longitudinal portion 323 so as to form the outer covering layer 11 and the inner lining layer 12, the width of the outer covering layer 11 is slightly larger than that of the inner lining layer 12.

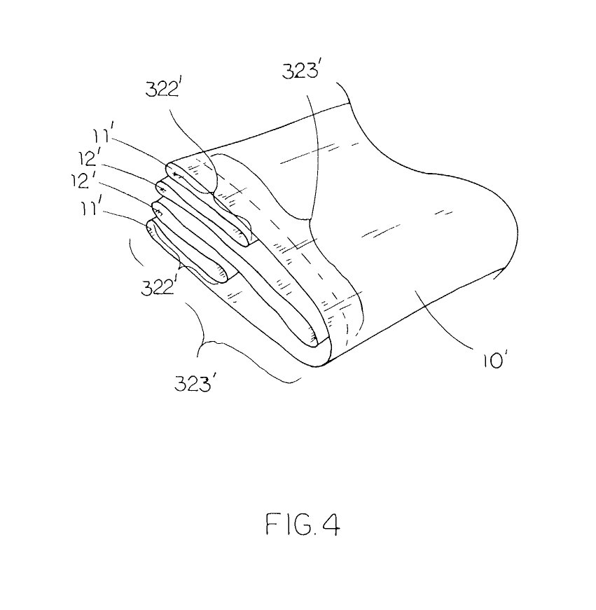

FIG. 4 illustrates an alternative mode of the bag body 10′ wherein the width of each of the outer covering layer 11′ is larger than that of each of the inner lining layer 12′ in such a manner that the space of the trash chamber 103′ is substantially reduced by shortening the width of the inner lining layers 12′. Accordingly, a width of each of the outer longitudinal portions 322′ of the tubular body 30′ is shorter than that of each of the inner longitudinal portions 323′ thereof in such a manner that when the outer longitudinal portions 322′ are overlappedly folded into the inner longitudinal portions 323′ respectively, the width of each of the outer covering layer 11′ is larger than that of each of the inner lining layer 12′. In other words, the size of the bag body 10′ can be easily adjusted by the folding method of the tubular body 30′.

It is worth mentioning that a plurality of plastic bags of the present invention are made during the manufacturing process wherein the plastic bags are integrally attached with each other head to tail and rolled up in a rolled manner for packaging as if the manufacturing process of the conventional plastic bags. Therefore, in step (4), a tearing line is formed next to the sealing edge 21 is formed on the tubular body 30 in such a manner that the user is able to tear off the plastic bag along the tearing line so as to detach the plastic bag from the roll of the plastic bags.

What is claimed is:

1. A plastic bag, comprising:
a bag body having an top opening, a bottom edge, and a chamber defined therein, wherein said bag body is adapted to be folded from a storage condition to an usage condition, wherein at the storage condition, said bag body is overlapped to form a longitudinal strap liked shape, and at the usage condition, said bag body is unfolded to expand said chamber with a round bottom portion for object collection; and
a bottom enhancement arrangement comprising means for sealing said bottom edge of said bag body to form a sealing edge of said bag body in such a manner that when said bag body is folded into the usage condition, said sealing edge is inwardly flipped inside said chamber while two bottom side portions of said bag body are downwardly folded to form said round bottom portion of said chamber, thereby a weight of objects collected within said chamber is evenly distributed so as to protect said sealing edge from being broken due to the weight of the objects.

2. The plastic bag, as recited in claim 1, wherein when said bag body is in the storage condition, said bag body has two outer covering layers, each having a longitudinal outer covering edge and a longitudinal inner covering edge, and two inner lining layers, each having a longitudinal outer lining edge and a longitudinal inner lining edge, overlappedly disposed between said two outer covering layers in layer by layer manner, wherein two outer sides of said outer covering layers are integrally connected at said inner covering edges thereof and two inner sides of said lining layers are integrally connected at said inner lining edges thereof, wherein two inner sides of said inner covering edges of said outer covering layers are integrally connected to two outer sides of said inner lining edges of said inner lining layers respectively.

3. The plastic bag, as recited in claim 2, wherein a width of each of said inner lining layers is slightly shorter than that of each of said outer covering layers in such a manner that when said bag body is in the storage condition, said inner lining layers are overlappedly and fittedly sandwiched between said outer covering layers so as to form said longitudinal strap liked shape.

4. The plastic bag, as recited in claim 2, wherein a width of each of said inner lining layers is shorter than that of each of said outer covering layers in such a manner that when said bag body is unfolded to the usage condition, said space of said chamber is substantially reduced by said width of said inner lining layers.

5. The plastic bag, as recited in claim 1, wherein said sealing means comprises at least a welding line made along said bottom edge of said bag body at the storage condition to form said sealing edge thereof.

6. The plastic bag, as recited in claim 2, wherein said sealing means comprises at least a welding line made along said bottom edge of said bag body at the storage condition to form said sealing edge thereof.

7. The plastic bag, as recited in claim 3, wherein said sealing means comprises at least a welding line made along said bottom edge of said bag body at the storage condition to form said sealing edge thereof.

8. The plastic bag, as recited in claim 4, wherein said sealing means comprises at least a welding line made along said bottom edge of said bag body at the storage condition to form said sealing edge thereof.

9. The plastic bag, as recited in claim 1, wherein the plastic bag is constructed by a producing method comprising the steps of:
(a) forming a plastic tubular body having two opening ends and two longitudinal half sections with respect to a centerline of said tubular body, wherein each of said longitudinal half sections has an outer longitudinal edge extended from one opening end to another opening end, an outer longitudinal portion transversely extended from said respective outer longitudinal edge, and an inner longitudinal portion defined between said respective outer longitudinal portion and said centerline;
(b) inwardly folding each of said outer longitudinal edges of said tubular body toward the centerline thereof to overlappedly receive said outer longitudinal portion in said inner longitudinal portion;
(c) folding said two longitudinal half sections with each other along said centerline of said tubular body; and
(d) sealing one of said opening ends of the tubular body to form said bottom sealing edge of said plastic bag while another opening end of said tubular body is constructed to be said top opening of said bag body.

10. The plastic bag, as recited in claim 2, wherein the plastic bag is constructed by a producing method comprising the steps of:
(a) forming a plastic tubular body having two opening ends and two longitudinal half sections with respect to a centerline of said tubular body, wherein each of said longitudinal half sections has an outer longitudinal edge extended from one opening end to another opening end, an outer longitudinal portion transversely extended from said respective outer longitudinal edge, and an inner longitudinal portion defined between said respective outer longitudinal portion and said centerline;
(b) inwardly folding each of said outer longitudinal edges of said tubular body toward the centerline thereof to overlappedly receive said outer longitudinal portion in said inner longitudinal portion;
(c) folding said two longitudinal half sections with each other along said centerline of said tubular body; and
(d) sealing one of said opening ends of the tubular body to form said bottom sealing edge of said plastic bag while another opening end of said tubular body is constructed to be said top opening of said bag body.

11. The plastic bag, as recited in claim 10, wherein in step (b), said outer covering layers and said inner lining layers are integrally formed by overlappedly folding said outer longitudinal portions in said inner longitudinal portions respectively.

12. The plastic bag, as recited in claim 11, wherein a width of each of said outer longitudinal portion is slightly shorter than that of each of said inner longitudinal portion in such a manner that after said outer longitudinal portion is overlappedly folded in said inner longitudinal portion, a width of each of said inner lining layers is slightly shorter than that of each of said outer covering layers, so that said inner lining layers are overlappedly and fittedly sandwiched between said outer covering layers so as to form said longitudinal strap liked shape.

13. The plastic bag, as recited in claim 11, wherein a width of each of said outer longitudinal portion is shorter than that of each of said inner longitudinal portion in such a manner that after said outer longitudinal portion is overlappedly folded in said inner longitudinal portion, a width of each of said inner lining layers is shorter than that of each of said outer covering layers, so that when said bag body is unfolded to said usage condition, said space of said chamber is substantially reduced by said width of said inner lining layers.

14. A method of producing a plastic bag, comprising the steps of:
(a) forming a plastic tubular body having two opening ends and two longitudinal half sections with respect to a centerline of said tubular body, wherein each of said longitudinal half sections has an outer longitudinal edge extended from one opening end to another opening end, an outer longitudinal portion transversely extended from said respective outer longitudinal edge, and an inner longitudinal portion defined between said respective outer longitudinal portion and said centerline;
(b) inwardly folding each of said outer longitudinal edges of said tubular body toward the centerline thereof to overlappedly receive said outer longitudinal portion in said inner longitudinal portion;
(c) folding said two longitudinal half sections with each other along said centerline of said tubular body; and
(d) sealing one of said opening ends of the tubular body of said bag body to form a bottom sealing edge of said plastic bag that is adapted to be folded from a storage condition to an usage condition, wherein at the storage condition, said bag body is overlapped to form a longitudinal strap liked shape, and at the usage condition, said sealing edge is inwardly flipped into a chamber of said bag body while two bottom side portions of said bag body are downwardly folded to form a round bottom portion of said chamber for evenly distributing a weight of objects collected therein.

15. The method, as recited in claim 14, wherein when said bag body is in the storage condition, said bag body has two outer covering layers, each having a longitudinal outer covering edge and a longitudinal inner covering edge, and two inner lining layers, each having a longitudinal outer lining edge and a longitudinal inner lining edge, overlappedly disposed between said two outer covering layers in layer by layer manner, wherein two outer sides of said outer covering layers are integrally connected at said inner covering edges thereof and two inner sides of said lining layers are integrally connected at said inner lining edges thereof, wherein, two inner sides of said inner covering edges of said outer covering layers are integrally connected to two outer sides of said inner lining edges of said inner lining layers respectively.

16. The method as recited in claim 15, in the step (b), wherein said outer covering layers and said inner lining layers are integrally formed by overlappedly folding said outer longitudinal portions in said inner longitudinal portions respectively.

17. The method, as recited in claim 16, wherein a width of each of said outer longitudinal portion is slightly shorter than that of each of said inner longitudinal portion in such a manner that after said outer longitudinal portion is overlappedly folded in said inner longitudinal portion, a width of each of said inner lining layers is slightly shorter than that of each of said outer covering layers, so that said inner lining layers are overlappedly and fittedly sandwiched between said outer covering layers so as to form said longitudinal strap liked shape.

18. The method, as recited in claim 16, wherein a width of each of said outer longitudinal portion is shorter than that of each of said inner longitudinal portion in such a manner that after said outer longitudinal portion is overlappedly folded in said inner longitudinal portion, a width of each of said inner lining layers is shorter than that of each of said outer covering layers, so that when said bag body is unfolded to said usage condition, said space of said chamber is substantially reduced by said width of said inner lining layers.

19. The method as recited in claim 17, in the step (d), wherein at least a welding line is formed along said bottom edge of said bag body at the storage condition to form said sealing edge thereof.

20. The method as recited in claim 18, in the step (d), wherein at least a welding line is formed along said bottom edge of said bag body at the storage condition to form said sealing edge thereof.
